(19) United States
(12) Patent Application Publication
(10) Pub. No.: US 2023/0129743 A1
(43) Pub. Date: Apr. 27, 2023

(54) Food Stuff Boiling Apparatus with Extraction Handle

(71) Applicants: Trevor P. Hewes, Louisville, KY (US); Thomas J. Ciesielka, New Bedford, MA (US)

(72) Inventors: Trevor P. Hewes, Louisville, KY (US); Thomas J. Ciesielka, New Bedford, MA (US)

(21) Appl. No.: 17/509,656

(22) Filed: Oct. 25, 2021

(51) Int. Cl. A47J 29/06

(52) U.S. Cl. CPC A47J 29/06

(57) ABSTRACT

A cooking apparatus for holding a plurality of eggs for immersion into a vessel filled with water for heating the water and cooking the eggs to a desired consistency. A first embodiment is adapted for placement of one or both egg holders over a central support base for cooking all or a portion of less than all of the eggs contained in the holders. A second embodiment of a single egg holder uses the egg holder as the support base for placement directly into the cooking vessel.

### BACKGROUND OF THE INVENTION

The present invention deals with the immersion, boiling and extraction of a plurality of eggs from a water containment vessel. Over many years a number of devices have been conceived and used that provide for similar functioning. Most, if not all, are structured to retain a number of eggs within an opening or support below the positioned egg to retain each egg in position throughout the cooking process and then to retain that cooked egg in position through the removal process from the water containment vessel. Some of the devices have a handle as part of the aggregated device, some have a designated connection point for using a handle to place and then remove the device within the water containment vessel. However, none of the devices have an egg retention cup that extends to encompass almost the entire egg and is thermally heat sensitive to assist in the cooking process.

One such device is described in U.S. Pat. 2,699,719 [Zelante] that shows a flat plate with a series of uniformly sized holes for accommodating a plurality of eggs for immersion in boiling water. The plate is supported by a downwardly extending support mounted to a handle that is capable of being clip mounted to the side of a water containment vessel such as a cooking pot. The device also contains a mechanical timer located in the handle for extracting the cooked eggs after a desired amount of elapsed time. The upwardly angled extraction position of the actuated plate could create an egg dislocating problem with the eggs disengaging from the apertures and falling back into the water. Further, the entire device is made of metal that will not uniformly transmit heat to the shell of the egg.

Another more recent device is described in U.S. Pat. 8,245,632 [Fields] that shows a multi-tray commercial egg cooker that can contain one dozen eggs per level that can be vertically positioned one tray atop another with a handle for temporary attachment to the upper exposed tray for placement and removal from a water containment vessel. Each tray can maintain each egg in a substantially upright position in a partial containment cradle. However, the cradles are shown to be larger than the circumference of the shorter diameter of the eggs and does not extend past that largest diameter upwards to maintain the egg with its longer oval-shaped dimension in a substantially vertical position. Further, the description is silent on the material of the tray assisting in the cooking of the egg by uniformly transmitting the heat of the boiling water to the eggshell more evenly than with the egg only partially exposed.

It is therefore an object of the present invention to provide an egg cooker that permits the more uniform cooking of eggs through egg retainers having a multiplicity of apertures exposing the shell directly to the heated water in the water containment vessel. It is also an object of the present invention to provide a single basket array of three egg retainers supported on a base with a loop at the base top for temporary attachment of a placement/extraction handle. Still a further object of the present invention is to provide a second basket array of three egg retainers that fit in an interspersed array with the baskets of the first and second array fitting between the baskets of the other array. It is yet another object of the present invention to provide a basket array of six egg retainers capable of holding and retaining all sizes of eggs, i.e., small, medium, large, extra-large, and jumbo, arrayed around a centrally located basket support having an upwardly extending loop for temporary attachment to a placement/extraction handle with each egg retainer basket having vertically oriented slots exposing the shell directly to the heated water in the water containment vessel. Further, another object of the present invention is to permit the heated water to come into contact with more of the outer shell of the eggs through a plurality of apertures and slots to allow for the more even heating of the eggs.

Other objects will appear hereinafter.

### SUMMARY OF THE INVENTION

The disclosed device is an egg cooking apparatus having multiple retainers for holding a plurality of eggs during the cooking process, where each egg retainer extends upward from a fixed connection point below on a base to substantially encompass the entirety of the longer oval distance or height of the egg and is made from a thermal transfer material to assist in the uniform cooking of the plurality of eggs. A central shaft is positioned onto the base and extends upward beyond the height of the egg retainers a distance higher than the topmost points of the plurality of placed and retained eggs with a loop at the top for use in connecting to a placement/extraction handle. The overall lateral dimension (diametric distance) of the egg cooking apparatus is configured to fit within a standard residential or commercial cooking pot capable of containing water for boiling. The base is configured to be positioned directly against the flat bottom of the cooking pot so as to provide both a stable environment for cooking the eggs and to enable the even transference of heating from the cooking pot and contained water through the material comprising the egg cooking apparatus. The handle is made from the same material as the described egg cooking apparatus.

A first embodiment of the egg cooker apparatus of the present invention shows a single basket array of three egg retainers arrayed with a 120° angle between respective centers of the egg retainers, a support base with top loop for supporting the basket array and a separate handle. The first embodiment also contemplates a second basket array rotated 60° right or left to permit the placement of the second basket array baskets in between each of the baskets of the first basket array to create an array of six egg containers mounted atop the same support base with its top loop for attaching temporarily to the handle.

What is described following is an egg cooking apparatus comprising a plurality of egg holding baskets arrayed around a central core at points separating each of the plurality of egg baskets equidistantly from each other with the central core extending upward into a fixed loop providing a connection for attaching a handle for placing and extracting the egg holding baskets in a cooking pot containing a liquid heating medium, e.g., water, for cooking eggs placed within the egg holding baskets. The plurality of egg holding baskets are grouped together in a first and second array that fit atop one another such that the lower array of the egg holding baskets fits over the central core and the upper array of the egg holding baskets fits over the central core and over the lower array of the egg holding baskets. The upper array of egg holding baskets fit in an interspersed array between the lower array of egg holding baskets with each of the lower and upper arrays of egg holding baskets having a central support with apertures for fitting over the loop and being retained in their desired separated positions.

Each of the egg holding baskets include a bottom and a plurality of apertures arrayed around the basket to permit heated water to contact more of the eggshell allowing for greater uniform cooking of an egg contained within said egg holding baskets. The central core includes a base member for supporting the egg holding baskets and maintaining stability of the egg cooking apparatus when placed in the cooking pot holding the egg holding baskets slightly separated from the bottom of the cooking pot. The handle includes a hook at its end that comes into contact with the upwardly extending loop of the egg cooking apparatus for placing and extracting the egg holding baskets in a cooking pot containing a liquid heating medium, e.g., water.

The array of the plurality of egg holding baskets is configured to position each of the egg holding baskets at points angularly arrayed about the central core at points equidistant from each other. Also, each of the first and second egg holding basket arrays are configured to position the egg holding baskets at points angularly arrayed about the central core at points equidistant from each other. In addition, each of the egg holding baskets, including each of the first and second egg holding basket arrays, are supported by a like number of arms that extend outward from the central core and form a portion of the inward facing surface of each egg holding basket. In the case of a single group of egg holding baskets, the bottom of each of the egg holding baskets are configured to rest on the bottom of a cooking pot to collectively form the base of the egg cooking apparatus.

### BRIEF DESCRIPTION OF THE DRAWINGS

For the purpose of illustrating the invention, there are shown in the drawings forms which are presently preferred; it being understood, however, that the invention is not limited to the precise arrangements and instrumentalities shown.

FIG. 1 is a perspective view of a first embodiment of the food stuff boiling apparatus of the present invention with both basket sections in overlying position atop a base section.

FIG. 2 is a top view of the first embodiment of the food stuff boiling apparatus of the present invention with both basket sections in overlying position.

FIG. 3 is a front view of the first embodiment of the food stuff boiling apparatus of the present invention with both basket sections in overlying position.

FIG. 4 is a bottom view of the first embodiment of the food stuff boiling apparatus of the present invention with both basket sections in overlying position.

FIG. 5 is a partial side view of the first embodiment of the food stuff boiling apparatus of the present invention rotated 30° counterclockwise with both basket sections in overlying position.

FIG. 6 is a perspective view of a single basket with placement and extraction handle of the first embodiment of the food stuff boiling apparatus of the present invention with the single basket section in overlying position atop a base section.

FIG. 7 is a top view of the first embodiment of the food stuff boiling apparatus of the present invention with the single basket section in overlying position atop a base section.

FIG. 8 is a front view of the first embodiment of the food stuff boiling apparatus of the present invention with the single basket section in overlying position atop a base section.

FIG. 9 is a bottom view of the first embodiment of the food stuff boiling apparatus of the present invention with the single basket section in overlying position atop a base section.

FIG. 10 is a side view of the first embodiment of the food stuff boiling apparatus of the present invention with the single basket section in overlying position atop a base section.

FIG. 11 is an exploded perspective view of the first embodiment of the food stuff boiling apparatus of the present invention.

FIG. 12 is a vertical section of the front view of the first embodiment of the food stuff boiling apparatus of the present invention of FIG. 3 taken along Line 12-12.

FIG. 13 is a vertical section of the side view of the first embodiment of the food stuff boiling apparatus of the present invention of FIG. 5 taken along Line 13-13.

FIG. 14 is an elevational view of the first embodiment of the food stuff boiling apparatus of the present invention immersed in a water containing vessel.

FIG. 15 is a perspective view of a second embodiment of the food stuff boiling apparatus of the present invention with placement and extraction handle.

FIG. 16 is a top view of the second embodiment of the food stuff boiling apparatus of the present invention.

FIG. 17 is a front view of the second embodiment of the food stuff boiling apparatus of the present invention.

FIG. 18 is a bottom view of the second embodiment of the food stuff boiling apparatus of the present invention.

FIG. 19 is a side view of the second embodiment of the food stuff boiling apparatus of the present invention.

FIG. 20 is an elevational view of the second embodiment of the food stuff boiling apparatus of the present invention immersed in a water containing vessel.

### DETAILED DESCRIPTION OF THE PREFERRED EMBODIMENTS

The following detailed description is of the best presently contemplated mode of carrying out the invention. The description is not intended in a limiting sense and is made solely for the purpose of illustrating the general principles of the invention. The various features and advantages of the present invention may be more readily understood with reference to the following detailed description taken in conjunction with the accompanying drawings.

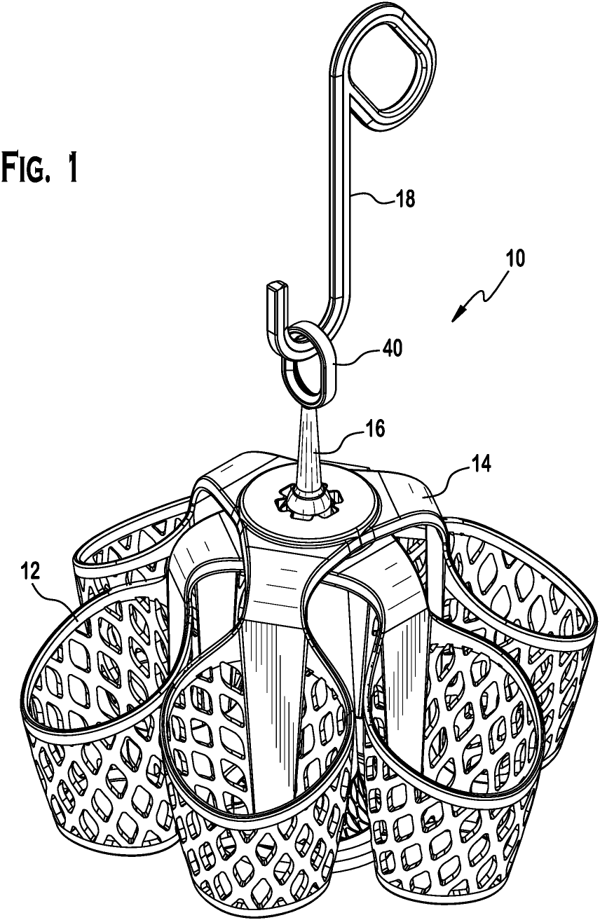

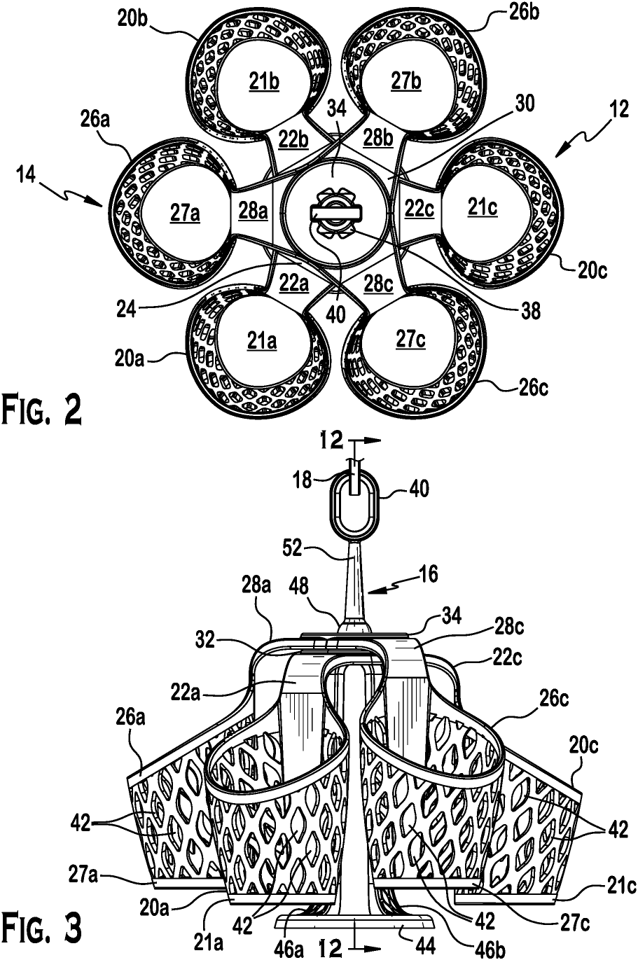

Referring now to the drawings in detail, where like numerals refer to like parts or elements, there is shown in FIG. 1 a perspective view of the egg cooker apparatus 10 of the present invention. The apparatus is comprised of a first egg basket array 12, a second basket array 14, a support base 16 and a handle 18. Referring to FIG. 2 and looking down at the apparatus from above, the first egg basket array 12 includes three egg baskets 20a, 20b and 20c arranged at angles of 120° to each other. Each of the baskets 20a, 20b, 20c is attached, respectively, to arms 22a, 22b, 22c extending outward and forming a central support 24 for the three egg baskets 20a, 20b, 20c. The second egg basket array 14 includes three egg baskets 26a, 26b and 26c also arranged at angles of 120° to each other. Each of the baskets 26a, 26b, 26c is attached, respectively, to arms 28a, 28b, 28c extending outward and forming a central support 30. The egg baskets 20a, 20b, 20c and 26a, 26b, 26c have closed bottoms 21a, 21b, 21c and 27a, 27b, 27c, respectively. Each of the egg baskets 20a, 20b, 20c and 26a, 26b, 26c and their respective support arms 22a, 22b, 22c and 28a, 28b, 28c are arrayed about a central axis 25 of the support base 16 at positions separated by 120° from a central point in each basket spaced around the central axis 25 on each of the first and second basket arrays 12, 14.

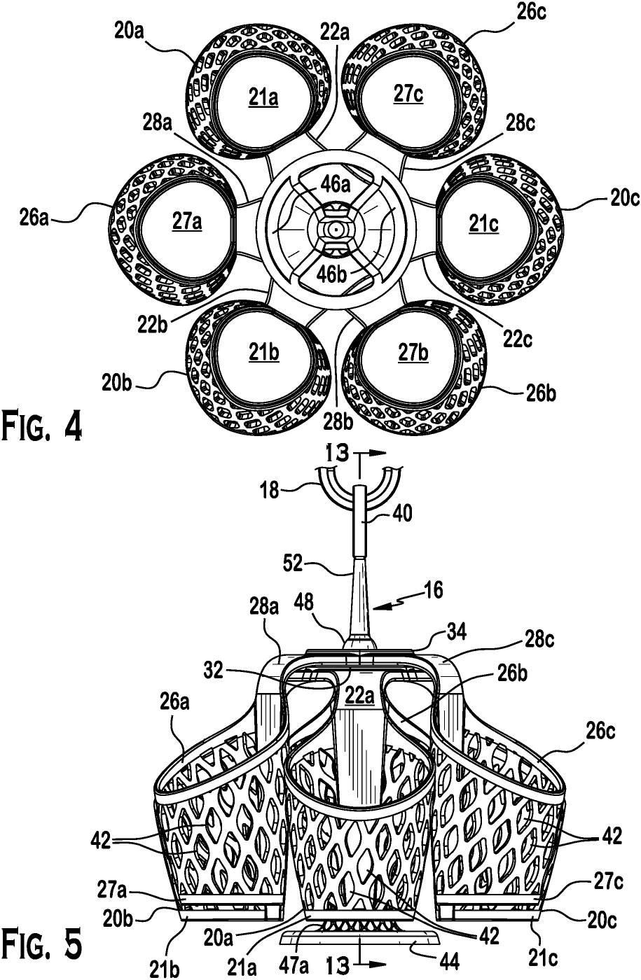

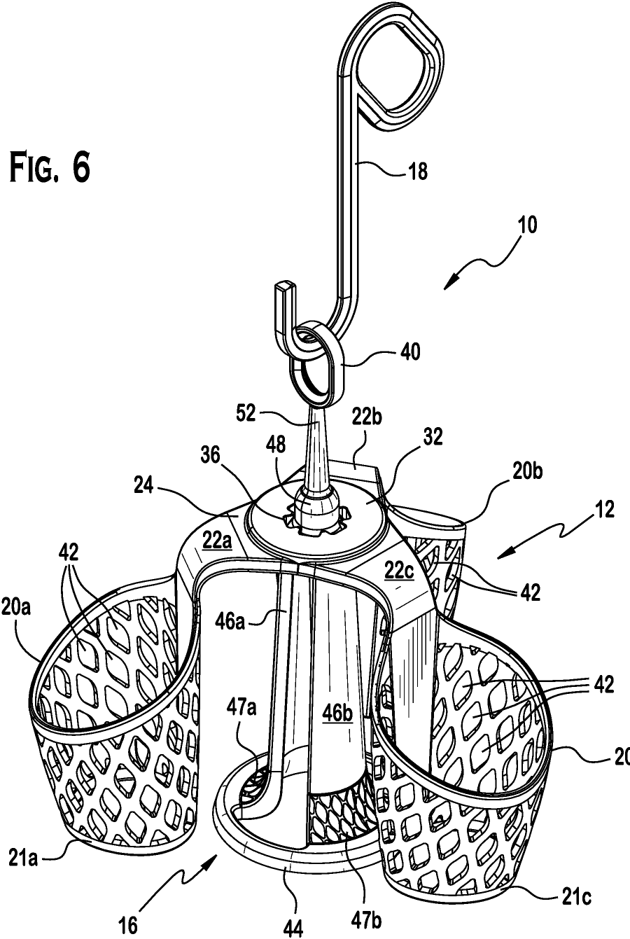

Expanding the reference now to FIGS. 2-5, formed atop the central supports 24, 30 of each basket array 12, 14 are raised portions 32, 34, respectively, for strengthening the supports 24, 30 and including apertures 36, 38 for accommodating the loop 40 at the top of the support base 16. Each of the apertures 36, 38 has three sets of opposing elongated cutouts extending beyond a central opening arranged at a 60° offset to each other from the central axis 25 formed by the support base 16 to accommodate each of the central supports 24, 30 of each basket array 12, 14 to pass over the loop 40 at the top of the support base 16 and allow each basket array 12, 14 to nest in substantial horizontal alignment. Each of the egg baskets 20a, 20b, 20c and 26a, 26b, 26c include a multiplicity of diamond shaped apertures 42 with rounded apices to permit heated water to contact more of the eggshell allowing for greater uniform cooking of the egg.

The support base 16 is comprised of a round base member 44 with paired arcuate vertical support members 46a, 46b with the arclength mimicking the circumference of the base member 44 and connected to the base by an open diamond shaped array 47a, 47b creating a means for permitting the water to pass through the bass 44 and permit the cooking apparatus 10 to more easily rest and remain positioned on the bottom of the cooking vessel. The vertical support members extend upward from the round base member 44 culminating in a centrally disposed joint 48 having a shoulder 50 for supporting and centering each of the egg basket arrays 12, 14. Extending upward from the centrally disposed joint 48 is a shaft 52 to which is attached at its uppermost point the loop 40.

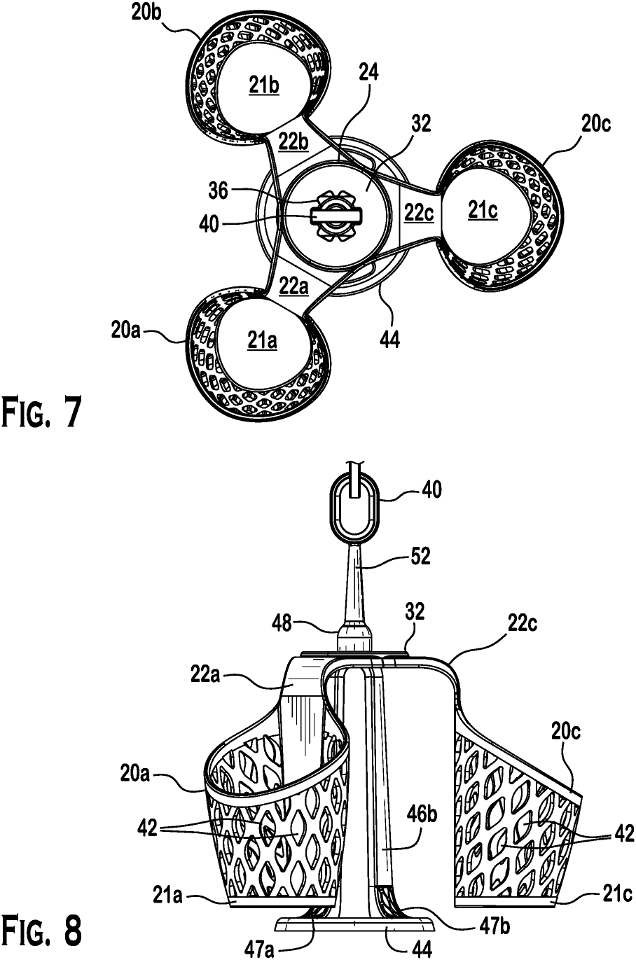

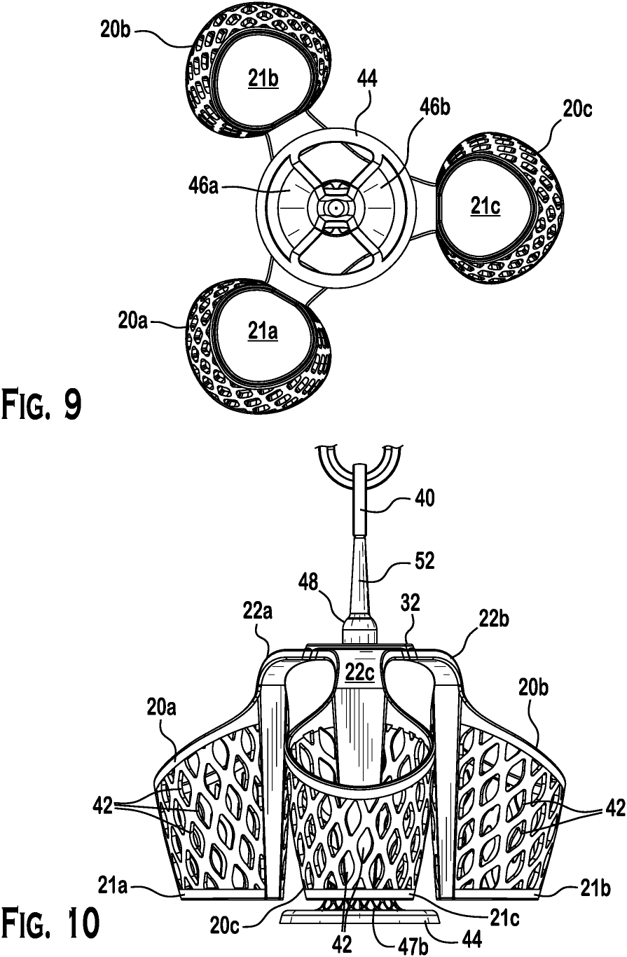

Referring now to FIGS. 6-10, the description will be limited to a single egg basket array by describing the egg basket array 12 in greater detail. Each of the three egg baskets 20a, 20b and 20c are attached, respectively, to arms 22a, 22b, 22c extending outward to form a central support 24 for the three egg baskets 20a, 20b, 20c. The egg baskets 20a, 20b, 20c have closed bottoms 21a, 21b, 21c, respectively, for supporting and cradling eggs of all sizes, i.e., small, medium, large, extra-large, and jumbo, to be cooked. Each of the egg baskets 20a, 20b, 20c and their respective support arms 22a, 22b, 22c are arrayed about the central axis 25 of the support base 16 at positions separated by 120° from each basket arrayed on the first basket array 12. Formed atop the central support 24 of basket array 12 is the raised portion 32 for strengthening the support 24 and includes the structured aperture 36 for accommodating the loop 40 at the top of the support base 16. The aperture 36 has three sets of opposing elongated cutouts extending beyond a central opening arranged at a 60° offset to each other from the central axis 25 formed by the support base 16 to accommodate the central support 24 of basket array 12 to pass over the loop 40 at the top of the support base 16 and allow the basket array 12 to rest atop the shoulder 50 of the common joint 48 of base 16. Egg baskets 20a, 20b, 20c also include a multiplicity of diamond shaped apertures 42 with rounded apices arrayed around the entirety of the baskets to permit the heated water to contact more of the eggshell allowing for greater uniform cooking of the egg.

The support base 16 is structured with the round base member 44 for contact with the flat bottom of the cooking vessel. Extending upward from the base member 44 are paired arcuate vertical support members 46a, 46b with the arclength mimicking the circumference of the base member 44 and connected to the base by an open diamond shaped array 47a, 47b. The open diamond shaped array 47a, 47b create a passthrough for permitting the water and any trapped air to pass and permit the cooking apparatus 10 to more easily rest and remain positioned on the bottom of the cooking vessel. The vertical support members 46a, 46b extend upward from the round base member 44 culminating in a centrally disposed joint 48 having a shoulder 50 for supporting and centering the egg basket array 12. Extending upward from the centrally disposed joint 48 is a shaft 52 to which is attached at its uppermost point the loop 40 providing the fixed upstanding attachment point for the handle 18 to enable placement and extraction of the egg cooking apparatus 10 from the cooking vessel.

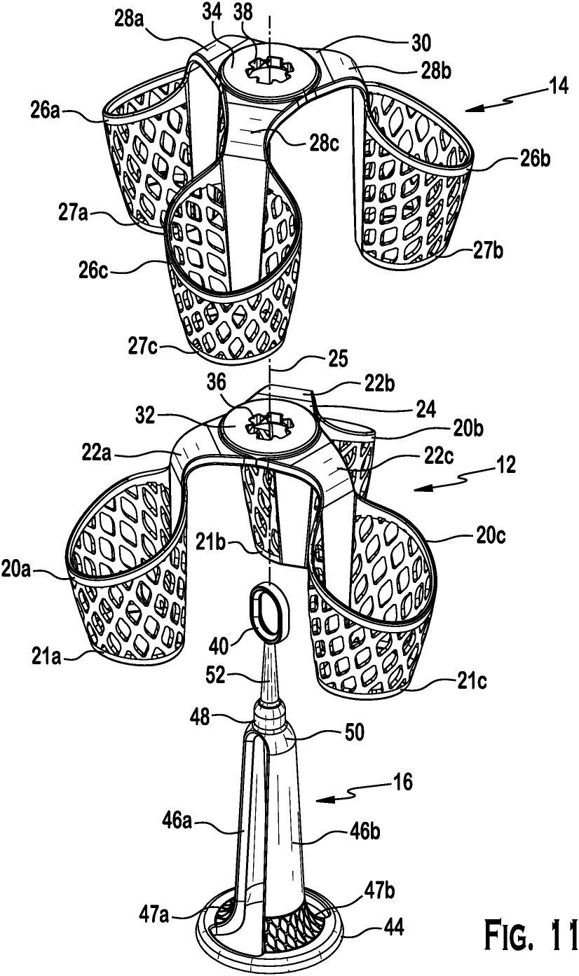

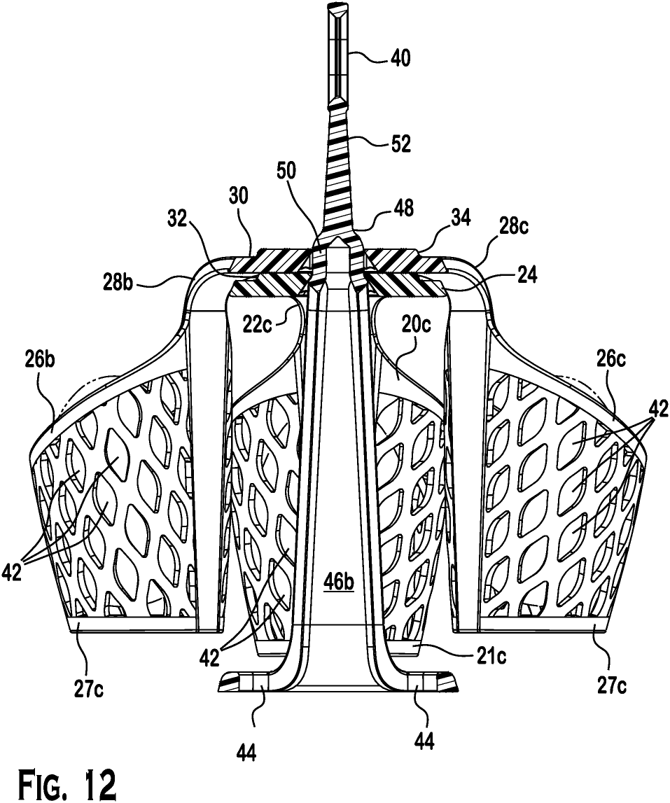

Referring to FIG. 11, the exploded view presented of the various elements of the invention is based on the perspective view of FIG. 1. The upstanding base 16 forms the structure for the nesting of each of the egg basket arrays 12, 14 that contact and rest atop the shoulder 50 of the common joint 48 of the base. The structured apertures 36, 38 have the three sets of outwardly extending opposing slots to allow each of the egg basket arrays 12, 14 to accommodate the loop 40 while simultaneously permitting the egg basket arrays 12, 14 to be offset by 60° and nest atop one another without lateral interference of the egg basket holders 20a, 20b, 20c with 26a, 26b, 26c. The assembled apparatus takes the form as shown in FIG. 1.

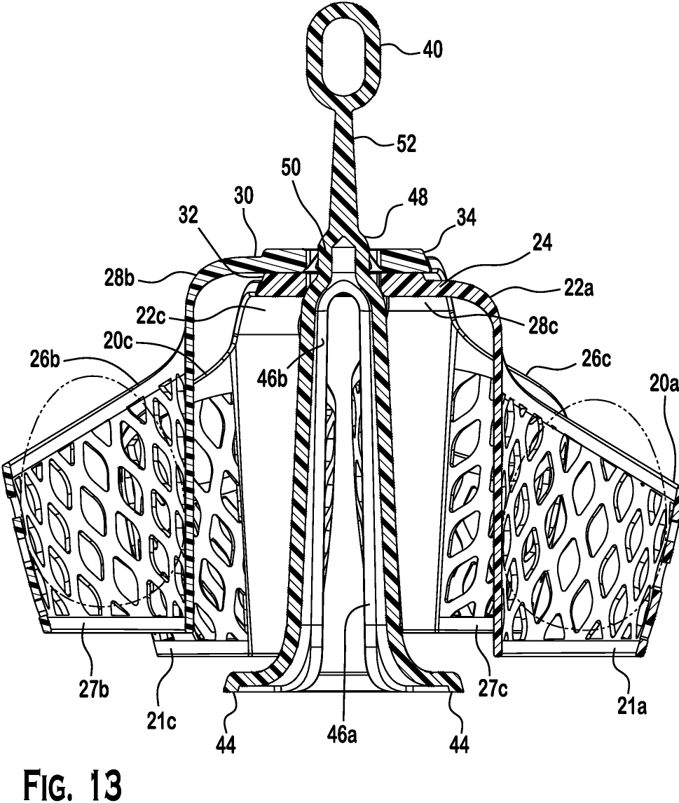

Looking now at FIG. 12, the sectional view shows an internal partial view of the egg cooking apparatus 10. As can be seen the egg baskets 26b, 26c and 20c have their respective support arms 28b, 28c and 22c extend down to the closed bottoms 27b, 27c and 21c along the portions of the respective egg baskets closest to the base 16. The support arms 28b, 28c and 22c provide the structural strength for supporting the cradled eggs (shown in dashed lines) in the egg baskets and provide the appropriately maintained distances of the egg baskets from the base 16 and between the egg baskets shown and the other egg baskets. Similarly, FIG. 13, another sectional view that also shows an internal partial view of the egg cooking apparatus 10 except that this view is of the cooking apparatus 10 rotated by 90°, shows egg baskets 26b, 20c, 26c and 20a with their respective support arms 28b, 22c, 28c and 22a extend down to the closed bottoms 27b, 21c, 27c and 21a along the portions of the respective egg baskets closest to the base 16. The support arms 28b, 22c, 28c and 22a provide the structural strength for supporting the cradled eggs (shown in dashed lines) in the egg baskets and provide the appropriately maintained distances of the egg baskets from the base 16 and between the egg baskets shown and the other egg baskets.

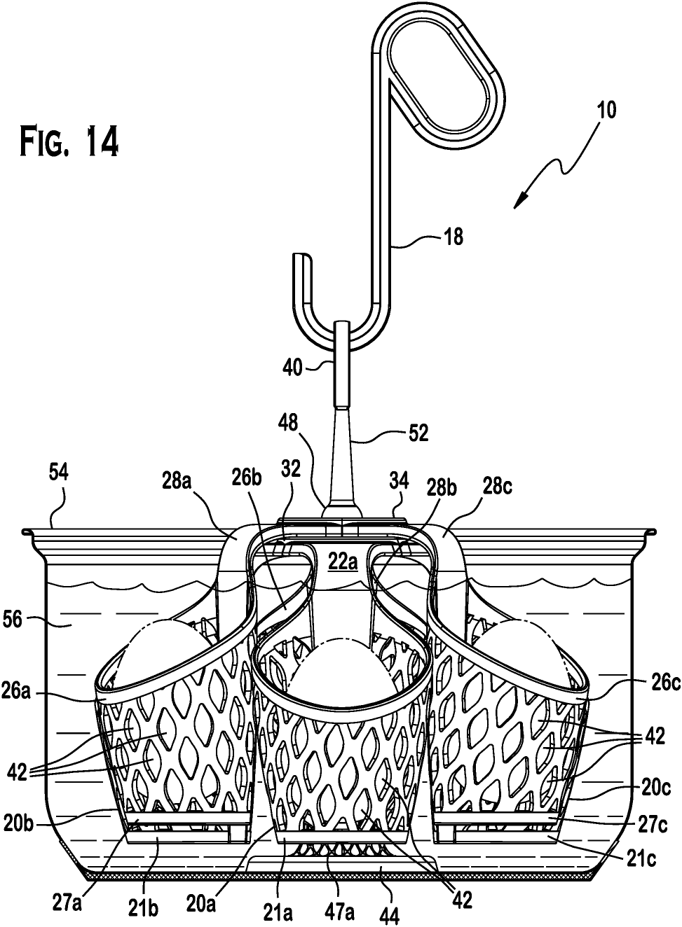

Referring to FIG. 14, the egg cooking apparatus 10 is shown placed within a cooking vessel 54 with the cradled eggs (shown in dashed lines) in egg baskets 20a, 26a and 26c immersed in water 56 for cooking. The handle 18 is used for the purposes of placement and extraction of the egg cooking apparatus 10 on and from the bottom of the cooking vessel 54 by temporarily attaching to the loop 40 at the top of the base 16. The handle 18 is removed from the loop 40 once the egg cooking apparatus 10 is properly positioned in the cooking vessel 54. When the eggs are finished cooking to the preferred consistency, e.g., soft or hard boiled, the handle 18 is used to connect to the loop 40 and extract the egg cooking apparatus from the water 56 in the cooking vessel 54. The eggs are either permitted to cool or be eaten promptly based on the desired or chosen consistency resulting from the cooking.

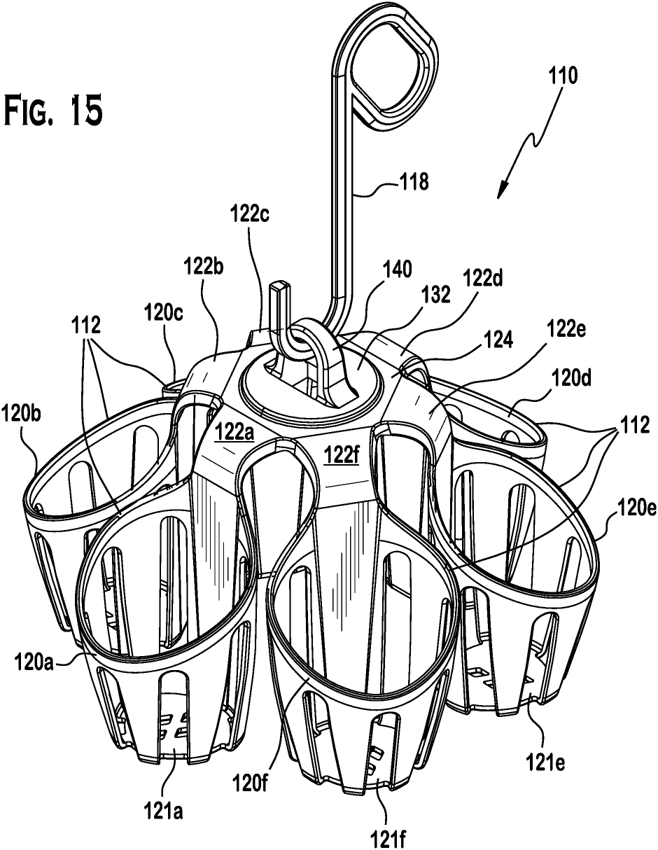

FIG. 15 shows a similar but differently constructed perspective view of a second embodiment of the cooking apparatus 10. This view shows the cooking apparatus 110 that is comprised of an egg basket array 112. The egg basket array 112 is configured into a six basket array of baskets 120a-120f that are attached, respectively, to arms 122a-122f extending outward and forming a central support 124 for the six egg baskets. Each of the egg baskets 120a-120f and their respective support arms 122a-122f are arrayed about an imaginary central axis of the egg cooking apparatus 110 at positions separated by 60° between a central point of one basket and a central point of the adjacent basket in the basket array 112. The egg baskets 120a-120f have perforated bottoms 121a-121f, respectively, with a plurality of openings 123a-123f to allow the egg cooking apparatus 110 to easily be submerged in water and permit the cooking apparatus 110 to more easily rest and remain positioned on the bottom of a cooking vessel. The bottoms of the respective egg baskets 120a-120f form the support base for the egg cooking apparatus 110.

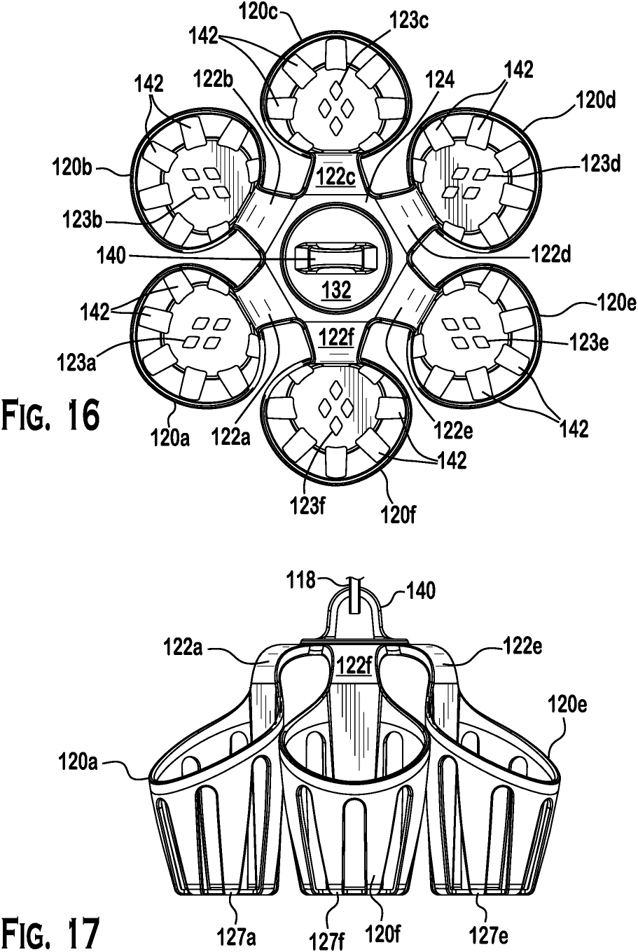

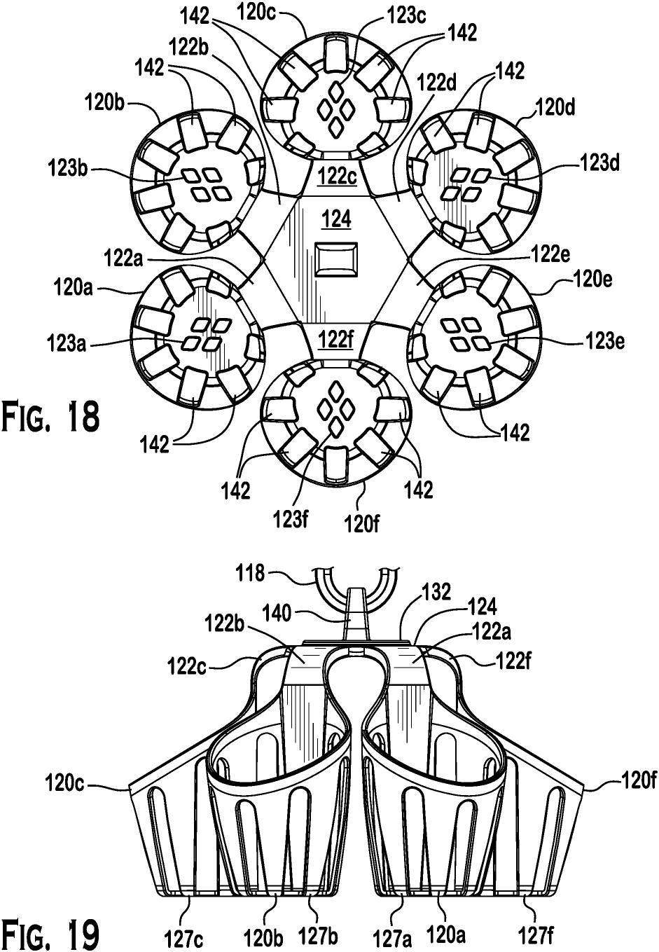

Expanding the reference now to include FIGS. 16-19, formed atop the central support 124 of the basket array 112 is raised portion 132 for strengthening the support 124 and including a loop 140 positioned at the top of and centrally located across the support 124. The loop 140 provides the fixed upstanding attachment point for the handle 118 to enable placement and extraction of the egg cooking apparatus 110 from a cooking vessel. Each of the egg baskets 120a-120f include a plurality of vertically oriented apertures 142 spaced around the basket wall to permit heated water to contact more of the eggshell allowing for greater uniform cooking of the egg.

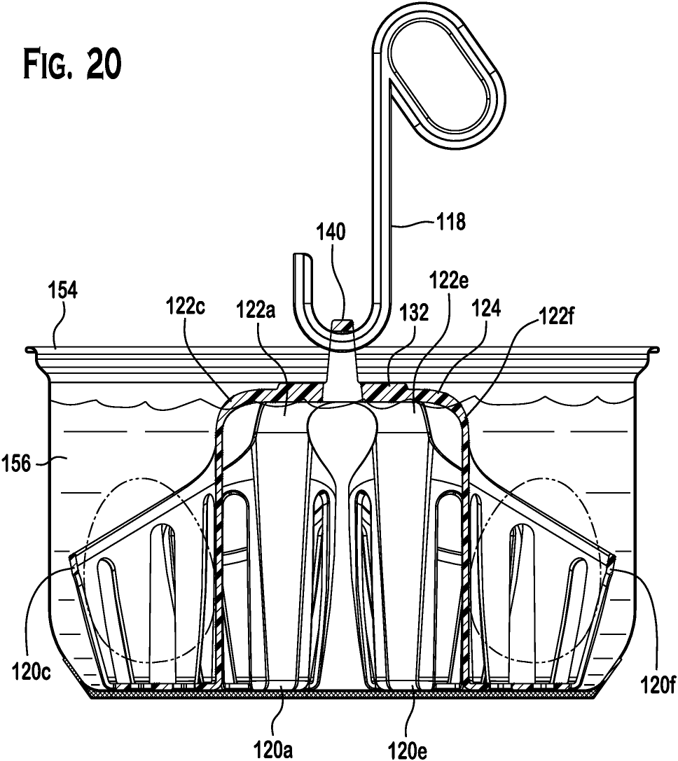

Looking now at FIG. 17, the sectional view shows a partial view of the egg cooking apparatus 110. As can be seen the egg baskets 120a, 120f and 120c have their respective support arms 122a, 122f and 122c extend down to the closed bottoms 127a, 127f and 127c along the portions of the respective egg baskets closest to the central axis. The support arms 122a, 122f and 122c provide the structural strength for supporting the eggs cradled in the egg baskets and provide the appropriately maintained distances of the egg baskets from the central axis and between the egg baskets shown and the other egg baskets. Similarly, FIG. 19, another partial view of the cooking apparatus 110 rotated by 90°, shows egg baskets 120c, 120b, 120a and 120f with their respective support arms 122c, 122b, 122a and 122f extend down to the closed bottoms 127c, 127b, 127a and 127f along the portions of the respective egg baskets closest to the central axis. The support arms 127c, 127b, 127a and 127f provide the structural strength for supporting the eggs cradled in the egg baskets and provide the appropriately maintained distances of the egg baskets from the central axis and between the egg baskets shown and the other egg baskets.

Referring to FIG. 20, the egg cooking apparatus 110 is shown placed within a cooking vessel 154 with the cradled eggs (shown in dashed lines) in egg baskets 120c, 120d, 120e and 120f immersed in water 156 for cooking. The handle 118 is used for the purposes of placement and extraction of the egg cooking apparatus 110 onto and from the bottom of the cooking vessel 154 by temporarily attaching to the loop 140 at the central portion of the top of the raised portion 132 for of the support 124. The handle 118 is removed from the loop 140 once the egg cooking apparatus 110 is properly positioned in the cooking vessel 154. When the eggs are finished cooking to the preferred consistency, e.g., soft or hard boiled, the handle 118 is used to connect to the loop 140 and extract the egg cooking apparatus 110 from the heated water 156 in the cooking vessel 154. The eggs are either permitted to cool or be eaten promptly based on the desired or chosen consistency resulting from the cooking.

The two embodiments described above are to be considered exemplary of the invention as any other number of baskets can be implemented surrounding the central core of the egg cooking apparatus. The number and position of the egg holding baskets is only limited by the size of the cooking vessel such that the diametric dimension of the egg cooking apparatus cannot exceed the diametric measurement of the cooking vessel. Thus, it is possible to have as few egg holding baskets as three arrayed around the central core or increase that number by one until the egg cooking apparatus exceeds the maximum measurement for the cooking vessel for immersion in the water for cooking. In the case of the first embodiment the number of egg holding baskets is preferred to be even in number so that every basket can be interspersed or nested on the same level. In the second embodiment the number of egg holding baskets is limited only by the size of the cooking vessel, e.g., the larger the diameter of the cooking vessel the greater number of egg holding baskets that can be arrayed about the central core without sacrificing the size of the baskets so that the smallest to the largest eggs can be cooked.

The cooking apparatus 10, 110 is desired to be manufactured of food grade silicone with a uniform matte finish, a Shore durometer of 60A, and provide a non-heat conducting material for more uniform cooking of the eggs. The handle 18, 118 is desired to be manufactured of food grade polypropylene, must withstand steam and boiling water without deformation, dishwasher safe, and have a glossy or polished defect-free finish. The overall cooking apparatus 10, 110 horizontal or width dimension inclusive of the basket arrays is presently desired to be approximately 7 inches and the overall height is presently desired to be approximately 5 inches. The overall height of the handle 18, 118 is presently desired to be approximately 4 ½ inches, its width presently desired to be approximately 3 inches, and its thickness presently desired to be approximately no greater than ¼ inch.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. An egg cooking apparatus comprising a plurality of egg holding baskets arrayed around a central core at points separating each of the plurality of egg baskets equidistantly from each other, said central core extending upward into a fixed loop providing a connection for attaching a handle for placing and extracting the egg holding baskets in a cooking pot containing a liquid medium to be heated for cooking eggs placed within the egg holding baskets.

2. The apparatus of claim 1 wherein, said plurality of egg holding baskets being grouped together in a first and second array fit atop one another such the lower array of the egg holding baskets fits over the central core and the upper array of the egg holding baskets fits over the central core and over the lower array of the egg holding baskets with the upper array of egg holding baskets fitting in an interspersed array between the lower array of egg holding baskets, said lower and upper arrays of egg holding baskets having a central support with apertures for fitting over the loop and being retained in their desired angularly separated positions.

3. The apparatus of claim 1 wherein each of the egg holding baskets include a bottom and a plurality of apertures arrayed around the basket to permit heated water to contact more of the eggshell allowing for greater uniform cooking of an egg contained within said egg holding baskets.

4. The apparatus of claim 2 wherein, the central core includes a base member for supporting the egg holding baskets and maintaining stability of the egg cooking apparatus when placed in the cooking pot holding the egg holding baskets slightly separated from the bottom of the cooking pot.

5. The apparatus of claim 1 wherein the handle includes a hook at its end that comes into contact with the upwardly extending loop of the egg cooking apparatus for placing in and extracting the egg holding baskets from the cooking pot containing the liquid heating medium.

6. The apparatus of claim 1 wherein, the array of the plurality of egg holding baskets is configured to position each of the egg holding baskets at points angularly arrayed about the central core at points equidistant from each other.

7. The apparatus of claim 2 wherein, each of the first and second egg holding basket arrays are configured to position the egg holding baskets at points angularly arrayed about the central core at points equidistant from each other.

8. The apparatus of claim 2 wherein, each of the egg holding baskets of each of the first and second egg holding basket arrays are supported by a like number of arms that extend outward from the central core and form a portion of the inward facing surface of each egg holding basket.

9. The apparatus of claim 1 wherein, each of the egg holding baskets are supported by a like number of arms that extend outward from the central core forming a portion of the inward facing surface of each egg holding basket.

10. The apparatus of claim 3 wherein, the bottom of each of the egg holding baskets are configured to rest on the bottom of the cooking pot to collectively form the base of the egg cooking apparatus.
